(19) United States
(12) Patent Application Publication
(10) Pub. No.: US 2008/0039663 A1
(43) Pub. Date: Feb. 14, 2008

(54) Method For Producing 3-Halophthalic Acid Dichlorides

(75) Inventors: Jorn Stolting, Koln (DE); Reinhard Lantzsch, Wuppertal (DE); Sergiy Pazenok, Solingen (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer Corp Science AG, Monheim (DE)

(21) Appl. No.: 11/792,113

(22) PCT Filed: Nov. 23, 2005
(86) PCT No.: PCT/EP05/12519

§ 371 Date: Jun. 1, 2007

(30) Foreign Application Priority Data
Dec. 4, 2004 (DE) 10 2004 058 519.9

(51) Int. Cl. C07F 15/00

(52) U.S. Cl. 568/300

(57) ABSTRACT

The invention relates to a novel process for preparing 3-halophthaloyl chlorides (3-halobenzene-1,2-dicarbonyl chlorides) from the corresponding 3-halophthalic anhydrides by reacting with phosgene in the presence of an N,N-dialkylformamide.

The invention relates to a novel process for preparing 3-halophthaloyl chlorides (3-halobenzene-1,2-dicarbonyl chlorides) from the corresponding 3-halophthalic anhydrides.

It is already known that phthaloyl chloride can be prepared from phthalic anhydride by reaction with suitable media for the introduction of chlorine (“chlorinating agents”).

For example, phthaloyl chloride is obtained by reacting phthalic anhydride with trichloromethane or tetrachloromethane in the presence of zinc chloride (cf. U.S. Pat. No. 2,051,096). However, this reaction requires very high temperatures; moreover, trichloromethane or tetrachloromethane are nowadays very problematic reaction components for industrial purposes.

Phthaloyl chloride can also be obtained by reacting phthalic anhydride with thionyl chloride in the presence of zinc chloride (cf. J. Am. Chem. Soc. 1937, 59, 206-208). This reaction too requires very high temperatures. Yield and quality of the products are not entirely satisfactory in this method.

Moreover, phthaloyl chloride can also be obtained by reacting phthalic anhydride with phosphorus(V) chloride (phosphorus pentachloride) (cf. Can. J. Chem. 1970, 48, 3566-3571). Here too, the yield of the desired product is very unsatisfactory.

A further known method for preparing phthaloyl chloride is the reaction of phthalic anhydride with trichloromethylisocyanide dichloride in the presence of iron (III) chloride (cf. DE-A 20 36 171). However, chlorocarbonylisocyanide dichloride is obtained here as a co-product.

Finally, the reaction of phthalic anhydride with phosgene in chlorobenzene in the presence of N,N-dimethylformamide is also known as a means of preparing phthaloyl chloride (cf. U.S. Pat. No. 3,810,940). Here too, the yield of the desired product is not entirely satisfactory.

Moreover, the preparation of phthaloyl chloride from phthalic anhydride is known (cf. WO 04/022520).

The objective of the invention was thus to provide a process suitable for industrial implementation, by which 3-halophthaloyl chlorides can be obtained in very good yields from readily available starting materials, for example 3-halophthalic anhydrides, using inexpensive assistants, with acceptable energy input and avoiding the occurrence of relatively large amounts of co-products.

It has now been found that, surprisingly, starting from 3-halophthalic anhydrides with use of phosgene as a medium for introducing chloride and as assistant from the group of the N,N-dialkylformamides and an inert diluent, the desired 3-halophthaloyl chloride product can be obtained in high yields and in very good quality when the metered addition of phosgene and N,N-dialkylformamide is not performed all at once, but rather the two components are each metered in continuously or “semi-continuously”.

In the context of the invention, continuously means that the particular reaction component (phosgene and/or N,N-dialkylformamide) is constantly metered into the reaction mixture uniformly over the entire reaction time.

In the context of the invention, “semi-continuously” means that the particular reaction component (phosgene and/or N,N-dialkylformamide) is metered into the reaction mixture in portions, divided over defined time intervals. The individual portions are preferably equally large and the individual time intervals are preferably equally long.

The present invention thus provides a process for preparing 3-halophthaloyl chlorides of the formula (I) 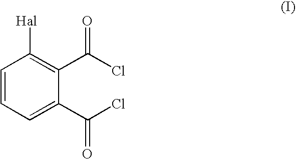
in which Hal is halogen,
in which phthalic anhydride of the formula (II) 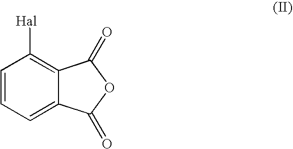
in which Hal is halogen,
is reacted with phosgene in the presence of an N,N-dialkylformamide of the formula (III) 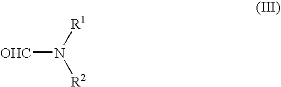
in which
R¹ and R² are each independently straight-chain or branched alkyl, and in the presence of an inert diluent, at temperatures between 20° C. and 150° C.,
characterized in that the amounts of the phosgene and of the N,N-dialkylformamide of the formula (III) used are each independently metered in continuously or “semi-continuously”.

After performing the reaction, the desired product can be obtained in high yield and in very good quality by distillation.

The 3-halophthalic anhydrides of the formula (II) to be used from starting materials in the process according to the invention are known, commercial synthesis chemicals. In the formula (II), Hal is preferably fluorine, chlorine, bromine or iodine, more preferably chlorine, bromine or iodine.

The phosgene used as a medium to introduce chlorine is likewise known.

The process according to the invention is performed using an N,N-dialkylformamide of the formula (III). In this formula (III), R¹ and R² are preferably each independently straight-chain or branched C₁-C₁₀-alkyl, more preferably C₁-C₆-alkyl.

Examples of N,N-dialkylformamides of the formula (III) include:

N,N-dimethylformamide, N,N-diethylformamide, N,N-di-n-propylformamide, N,N-diisopropylformamide, N,N-di-n-butylformamide and N,N-diisobutylformamide.

The N,N-dialkylformamides are known organic synthesis chemicals or reagents.

The process according to the invention is performed in the presence of an inert diluent. Useful diluents include in particular: hydrocarbons such as pentane, hexane, heptane, octane, cyclohexane, methylcyclohexane, benzene, toluene, xylene, and halogenated hydrocarbons such as dichloromethane, trichloromethane, tetrachloromethane, chlorobenzene or dichlorobenzene. Toluene and chlorobenzene are particularly preferred as diluents.

The process according to the invention can be performed within a relatively wide temperature range. Preference is given to performing the reaction at temperatures between 40° C. and 120° C., in particular between 55° C. and 100° C.

The process according to the invention is performed generally under standard pressure. However, it is also possible to perform the process according to the invention under elevated or reduced pressure—generally between 0.1 bar and 50 bar, preferably between 1 bar and 10 bar.

To perform the process according to the invention, for 1 mol of 3-halophthalic anhydride of the formula (II), generally between 1.2 mol and 2.5 mol, preferably between 1.4 mol and 2.2 mol of phosgene, and also between 0.01 mol and 0.20 mol, preferably between 0.02 and 0.10 mol of N,N-dialkylformamide of the formula (III) are used.

In a preferred embodiment of the process according to the invention, a 3-halophthalic anhydride is initially charged in an inert diluent, and the mixture is heated to the reaction temperature.

The phosgene and the N,N-dialkylformamide of the formula (III) are then each metered in either continuously over the entire reaction time or metered in in portions “semi-continuously”, i.e. distributed over roughly equally long time intervals and divided into roughly equally large portions according to the number of these time intervals.

In a preferred variant, both the phosgene and the N,N-dialkylformamide of the formula (III) are metered in continuously.

In another preferred variant, both the phosgene and the N,N-dialkylformamide of the formula (III) are metered in “semi-continuously” divided between several portions.

In a further preferred variant, the phosgene is metered in continuously, while the N,N-dialkylformamide of the formula (III) is metered in “semi-continuously” divided between several portions.

In a further preferred variant, the phosgene is metered in “semi-continuously” divided between several portions, while the N,N-dialkylformamide of the formula (III) is metered in continuously.

A particularly advantageous reaction time in each case is from 5 to 15 hours (depending on the batch size), in which case a metered addition of the N,N-dialkylformamide of the formula (III) is advantageously effected every 15 to 90 minutes, and the phosgene is metered in continuously; or “semi-continuously”.

After the end of the addition of phosgene and N,N-dialkylformamide of the formula (III), the reaction mixture is advantageously kept at the reaction temperature specified for another 1 to 2 hours and then worked up under reduced pressure by distillation.

The inventive preparation of 3-halophthaloyl chlorides is described in the examples which follow, which illustrate the above description further. However, the examples should not be interpreted in a restrictive manner.

### PREPARATION EXAMPLES

### Example 1

### 3-Chlorophthaloyl Chloride

In 150 ml of toluene, 182.5 g of chlorophthalic anhydride and 5 g of dibutylformamide are taken up. The mixture is heated to 70° C. At this temperature, 138.5 g of phosgene are metered in over 2-6 hours.

Subsequently, the reaction mixture is stirred at 70° C. for another 1 hour. Excess phosgene and diluent are removed under reduced pressure. The crude product obtained as the residue is purified by distillation under reduced pressure.

This gives 226 g (91% of theory) of 3-chlorophthaloyl chloride (boiling point 140° C., 8 mbar).

### Example 2

### 3-Chlorophthaloyl Chloride

In 180 ml of chlorobenzene, 182.5 g of chlorophthalic anhydride and 7 g of dibutylformamide are taken up. The mixture is heated to 70° C. At this temperature, 138.5 g of phosgene are metered in over 2-6 hours.

Subsequently, the reaction mixture is stirred at 70° C. for another 1 hour. Excess phosgene and diluent are removed under reduced pressure. The crude product obtained as the residue is purified by distillation under reduced pressure.

This gives 225 g (95% of theory) of 3-chlorophthaloyl chloride (boiling point 140° C., 8 mbar).

### Example 3

### 3-Bromophthaloyl Chloride

In 200 ml of chlorobenzene, 227 g of bromophthalic anhydride and 5 g of dibutylformamide are taken up. The mixture is heated to 70° C. At this temperature, 138.5 g of phosgene are metered in over 2-6 hours.

Subsequently, the reaction mixture is stirred at 70° C. for another 1 hour. Excess phosgene and diluent are removed under reduced pressure. The crude product obtained as the residue is purified by distillation under reduced pressure.

This gives 253 g (90% of theory) of 3-bromophthaloyl chloride (boiling point 160° C., 8 mbar).

### Example 4

### 3-Iodophthaloyl Chloride

In 200 ml of chlorobenzene, 274 g of iodophthalic anhydride and 7 g of dibutylformamide are taken up. The mixture is heated to 75° C. At this temperature, 170 g of phosgene are metered in over 2-6 hours.

Subsequently, the reaction mixture is stirred at 70° C. for another 1 hour. Excess phosgene and diluent are removed under reduced pressure. The crude product obtained as the residue is purified by distillation under reduced pressure.

This gives 288 g (88% of theory) of 3-iodophthaloyl chloride.

1. A process for preparing 3-halophthaloyl chlorides of the formula (I) 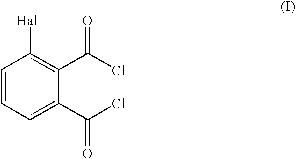
in which Hal is halogen, comprising reacting
a phthalic anhydride of the formula (II) 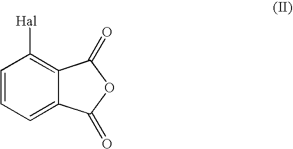
in which Hal is halogen,
with phosgene in the presence of an N,N-dialkylformamide of the formula (III) 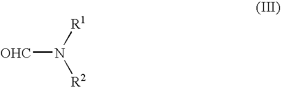
in which
R¹ and R² are each independently straight-chain or branched alkyl, and in the presence of an inert diluent, at a temperature between 20° C. and 150° C.,
wherein said phosgene and said N,N-dialkylformamide of the formula (III) are each independently added continuously or semi-continuously.

2. The process according to claim 1, wherein said N,N-dialkylformamide of the formula (III) is added continuously.

3. The process according to claim 1, wherein said N,N-dialkylformamide of the formula (III) is added semi-continuously.

4. The process according to claim 1, wherein said phosgene is added continuously.

5. The process according to claim 1, wherein said phosgene is added semi-continuously.
